(19) United States
(12) Patent Application Publication
(10) Pub. No.: US 2023/0008430 A1
(43) Pub. Date: Jan. 12, 2023

(54) METHOD FOR UPDATING NON-LINEAR LOOK-UP TABLE, APPARATUS FOR UPDATING NON-LINEAR LOOK-UP TABLE, AND OPTICAL RECEIVER

(71) Applicant: FUJITSU LIMITED, Kawasaki-shi (JP)

(72) Inventors: Ke ZHANG, Beijing (CN); Zhenning TAO, Beijing (CN)

(73) Assignee: FUJITSU LIMITED, Kawasaki-shi (JP)

(21) Appl. No.: 17/833,973

(22) Filed: Jun. 7, 2022

(30) Foreign Application Priority Data
Jul. 7, 2021 (CN) 202110767895.1

(51) Int. Cl. H04B 10/61; H04B 10/40

(52) U.S. Cl. CPC H04B 10/6163; H04B 10/40; H04B 10/6164

(57) ABSTRACT

A method for updating a non-linear look-up table, an apparatus for updating a non-linear look-up table, and an optical receiver. The method for updating a non-linear look-up table includes: performing suppression processing on residual linear ISI contained in an input look-up table in an iterative update process of a look-up table to obtain a processed look-up table. The method eliminates adverse effects of a residual linear ISI in real time during an iterative update process of a LUT, so that a generated LUT coefficient does not continue to diverge along an iteration process, which ensures stable operation of pre-compensating on nonlinearity of an optical transmitter device.

### CROSS-REFERENCE TO RELATED APPLICATIONS

This application is based on and hereby claims priority to Chinese Application No. 202110767895.1, filed Jul. 7, 2021, in the State Intellectual Property Office of China, the disclosure of which is incorporated herein by reference.

### TECHNICAL FIELD

The present disclosure relates to the field of communications, particularly relates to a method for updating a non-linear look-up table, an apparatus for updating a non-linear look-up table, and an optical receiver.

### BACKGROUND

In an optical communication system, nonlinearity of electrical and optical devices such as a digital to analog converter (DAC), a driving amplifier and an optical modulator (collectively referred to as optical transmitter devices) will produce serious Inter-symbol Interference (ISI) and causes transmission performance degradation.

Anon-liner Look Up Table (LUT) has been proved to be a method which can effectively eliminate nonlinear damages of optical transmitter devices. That is, training of the LUT is completed by constructing a back-to-back scenario beforehand, then the trained LUT is deployed at a transmitter end to perform nonlinear pre-compensation. However, due to the effects of temperature and device aging, nonlinear characteristics of each optical transmitter device will change with time. The nonlinear pre-compensation performance of these LUTs obtained through static experimental training may deteriorate seriously.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the BACKGROUND of the present disclosure.

### SUMMARY

According to a first aspect of the embodiments of the present disclosure, an apparatus for updating a non-linear look-up table is provided, wherein the apparatus includes:

a processing unit configured to perform suppression processing on residual linear inter-symbol interference (ISI) contained in an input look-up table in an iterative update process of a look-up table to obtain a processed look-up table.

In some embodiments, the processing unit is configured to:
calculate a correlation coefficient r(i) between a symbol sequence vector V(i) and a nonlinear coefficient vector S of the input look-up table;
calculate a linear ISI related to the symbol sequence vector V(i) by using the correlation coefficient r(i); and
remove the linear ISI related to the symbol sequence vector V(i) from the nonlinear coefficient vector S to obtain the processed look-up table.

In some embodiments, the processing unit is configured to:
calculate a crosstalk coefficient vector W between a symbol sequence matrix P and a nonlinear coefficient vector S of the input look-up table;
calculate a linear ISI by using the crosstalk coefficient vector W; and
remove the linear ISI from the nonlinear coefficient vector S to obtain the processed look-up table.

In some embodiments, the processing unit is configured to:

multiply the input look-up table by a first factor α to obtain the processed look-up table, a value of the first factor α being greater than 0 and less than 1.

According to another aspect of the embodiments of the present disclosure, a method for updating a non-linear look-up table is provided, wherein the method includes:

performing suppression processing on residual linear ISI contained in an input look-up table in an iterative update process of a look-up table to obtain a processed look-up table.

According to a further aspect of the embodiments of the present disclosure, an optical receiver is provided, the optical receiver includes:
a photoelectric converter configured to perform photoelectric conversion on a received optical signal to obtain a photoelectrically converted signal;
an analog-to-digital converter configured to perform analog-to-digital conversion on the photoelectrically converted signal to obtain an analog-to-digital converted signal;
a signal processor configured to perform digital signal processing on the analog-to-digital converted signal to obtain a signal after digital signal processing;
a decider configured to perform decision on the signal after digital signal processing to obtain a signal after decision; and
a decoder configured to decode the signal after decision to obtain a decoded signal;
the optical receiver further includes:
an apparatus for updating a non-linear look-up table, which updates the non-linear look-up table according to the signal after digital signal processing and the signal after decision to obtain an updated look-up table and feed back the updated look-up table to a peer optical transmitter,
the apparatus for updating a non-linear look-up table being configured to perform suppression processing on residual linear ISI contained in an input look-up table in an iterative update process of a look-up table to obtain a processed look-up table.

An advantage of the embodiments of the present disclosure lies in: according to the embodiments of the present disclosure, adverse effects of a residual linear ISI are eliminated in real time during an iterative update process of a LUT, so that a generated LUT coefficient does not continue to diverge along an iteration process, which ensures stable operation of pre-compensating on nonlinearity of an optical transmitter device.

Referring to the later description and figures, specific implementations of the present disclosure are disclosed in detail, indicating a manner that the principle of the present disclosure can be adopted. It should be understood that the implementations of the present disclosure are not thereto limited in terms of the scope. Within the scope of the terms of the appended claims, the implementations of the present disclosure include many changes, modifications and equivalents.

Features that are described and/or shown with respect to one implementation can be used in the same way or in a similar way in one or more other implementations, can be combined with or replace features in the other implementations.

It should be emphasized that the term “comprises/comprising/includes/including” when being used herein refers to the presence of a feature, a whole piece, a step or a component, but does not exclude the presence or addition of one or more other features, whole pieces, steps or components.

### BRIEF DESCRIPTION OF THE DRAWINGS

An element and a feature described in a figure or an implementation of the present embodiments of the present disclosure can be combined with an element and a feature shown in one or more other figures or implementations. In addition, in the figures, similar numerals represent corresponding components in several figures, and can be used to indicate corresponding components used in more than one implementation.

The included figures are used to provide a further understanding on the embodiments of the present disclosure, constitute a part of the Description, are used to illustrate the implementations of the present disclosure, and expound the principle of the present disclosure together with the text description. Obviously, the figures in the following description are only some embodiments of the present disclosure. For those of ordinary skills in the art, other figures may be obtained according to these figures without making an inventive effort. In the figures:

FIG. 1 is a schematic diagram illustrating an example of an apparatus for updating a non-linear look-up table of the embodiments of the present disclosure;

FIG. 2 is a schematic diagram illustrating an implementation of a processing unit according to an embodiment of the present disclosure;

FIG. 3 is a schematic diagram illustrating another implementation of a processing unit according to an embodiment of the present disclosure;

FIG. 4 is a schematic diagram illustrating another example of an apparatus for updating a non-linear look-up table of the embodiments of the present disclosure;

FIG. 5 is a schematic diagram illustrating a further example of an apparatus for updating a non-linear look-up table of the embodiments of the present disclosure;

FIG. 6 is a schematic diagram illustrating more example of an apparatus for updating a non-linear look-up table of the embodiments of the present disclosure;

FIG. 7 is a schematic diagram illustrating an implementation of a method for updating a non-linear look-up table of the embodiments of the present disclosure;

FIG. 8 is a schematic diagram illustrating an implementation of the operation 701 in the method of FIG. 7 according to an embodiment of the present disclosure;

FIG. 9 is a schematic diagram illustrating another implementation of the operation 701 in the method of FIG. 7 according to an embodiment of the present disclosure;

FIG. 10 is a schematic diagram illustrating a further implementation of the operation 701 in the method of FIG. 7 according to an embodiment of the present disclosure;

FIG. 11 is a schematic diagram illustrating another implementation of a method for updating a non-linear look-up table of the embodiments of the present disclosure;

FIG. 12 is a schematic diagram illustrating a further implementation of a method for updating a non-linear look-up table of the embodiments of the present disclosure;

FIG. 13 is a schematic diagram illustrating a more implementation of a method for updating a non-linear look-up table of the embodiments of the present disclosure;

FIG. 14 is a schematic diagram illustrating an example of an optical receiver of the embodiments of the present disclosure;

FIG. 15 is a schematic diagram illustrating an example of an optical transmitter of the embodiments of the present disclosure;

FIG. 16 is a schematic diagram illustrating an optical communication system of the embodiments of the present disclosure.

### DESCRIPTION OF IMPLEMENTATIONS

Referring to the figures, through the following Description, the above and other features of the present disclosure will become obvious. In the Description and figures, particular implementations of the present disclosure have been disclosed as being indicative of some of the implementations in which the principles of the disclosure may be employed. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or temporal orders, etc. of these elements, and these elements should not be limited by these terms. The term “and/or” includes any one and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to......”, the term “based on” should be understood as “at least partially based on......”, unless the context clearly indicates otherwise.

The inventor finds that a current iterative LUT training method can track changes of nonlinearity of optical transmitter devices. However, the iterative LUT training method does not consider some residual linear inter-symbol interference contained in a generated LUT, such ISI will continuously accumulate along an iterative process, which causes a LUT coefficient to continuously diverge. This is not acceptable for the continuous and stable operation of an adaptive nonlinear pre-compensation method.

In order to solve the above problem or other similar problems, the embodiments of the present disclosure provide a method for updating a non-linear look-up table, an apparatus for updating a non-linear look-up table, and an optical receiver.

Various implementations of the embodiments of the present disclosure will be described below with reference to the figures.

### Embodiments of the First Aspect

The embodiments of the present disclosure provide an apparatus for updating a non-linear look-up table. The apparatus is applied to an optical receiving end, can be configured in an optical receiver, or outside the optical receiver, for example for an optical transceiver including an optical transmitter and an optical receiver, the apparatus can be configured to be coupled to the optical receiver, but the present disclosure is not limited to this.

FIG. 1 is a schematic diagram of an example of an apparatus for updating a non-linear look-up table of the embodiments of the present disclosure. As shown in FIG. 1, the apparatus 100 includes: a processing unit 101 configured to perform suppression processing on residual linear ISI contained in an input look-up table in an iterative update process of a look-up table to obtain a processed look-up table. Via the processed look-up table, an updated look-up table in which the linear ISI is removed can be obtained. By feeding back the updated look-up table to the optical transmitter in real time, dynamic and adaptive pre-compensation on nonlinearity of an optical transmitter device can be realized.

According to the embodiments of the present disclosure, adverse effects of a residual linear ISI are eliminated in real time during an iterative update process of a LUT, so that a generated LUT coefficient does not continue to diverge along an iteration process, which ensures stable operation of pre-compensating on nonlinearity of an optical transmitter device.

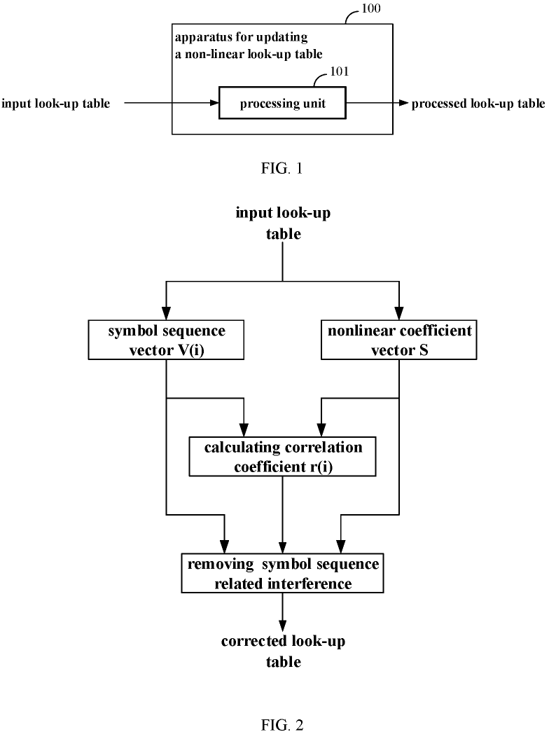

FIG. 2 is a schematic diagram of an implementation of the processing unit 101. As shown in FIG. 2, in some embodiments, the processing unit 101 is configured to:
calculate a correlation coefficient r(i) between a symbol sequence vector V(i) and a nonlinear coefficient vector S of an input look-up table;
calculate a linear ISI related to the symbol sequence vector V(i) by using the correlation coefficient r(i); and
remove the linear ISI related to the symbol sequence vector V(i) from the nonlinear coefficient vector S to obtain the processed look-up table.

Taking the input look-up table as a look-up table containing 1024 entries as shown in the following Table 1 as an example, the input look-up table consists of 1024 different symbol sequences and corresponding nonlinear coefficients, a length of all the symbol sequences is 5, thus a symbol matrix of 1024×5 can be formed.

Table 1

| Symbol sequences with a length being 5 | Nonlinear coefficients |
|---|---|
| [-3 -3 -3 -3 -3] | Δ 1 |
| [-3 -3 -3 -3 -1] | Δ 2 |
| ...... | ...... |
| [33333] | Δ 1024 |

In the above embodiments, the processing unit 101 can split the symbol matrix into five column vectors V(1), V(2), V(3), V(4) and V(5), which respectively correspond to the first, second, third, fourth and fifth symbols of the symbol sequence with a length being 5, meanwhile a nonlinear coefficient vector S = [Δ1 Δ2 ... Δ1024]^{T} is obtained

In the above embodiments, the processing unit 101 can calculate a correlation coefficient r(i) between symbol sequence vectors V(1) to V(5) and a nonlinear coefficient vector S, the calculation formula is as follows:

$$\text{r} \left(\text{i}\right) = \frac{c o v \left[V \left(i\right) , S\right]}{\sqrt{V a r \left[V \left(i\right)\right] V a r \left(S\right)}} \text{, i} = 1 , 2 , 3 , 4 , 5$$

In Equation 1, cov[V(i), S] represents a covariance between V(i) and S, Var[V(i)] and Var(S) respectively represent variances of vectors V(i) and S. The correlation coefficient r(i) represents a magnitude of residual linear ISI contained in the nonlinear coefficient vector.

In the above embodiments, the processing unit 101 can remove linear interference related to the symbol sequence vector V(i) in the nonlinear coefficient vector S by using correlation coefficient r(i) which is obtained upon calculation, the calculation formula is as follows:

$${S}^{′} = S - \sum {}_{i = 1}^{5} r \left(i\right) V \left(i\right) \sqrt{\frac{V a r \left(S\right)}{V a r [ V \left(i\right) ]}}$$

In Equation 2, S‘ represents a nonlinear coefficient vector that has been linearly corrected. By replacing original S in the input look-up table with S’, a corrected look-up table (i.e., a processed look-up table) can be outputted from the processing unit 101.

In the above embodiments, taking that the input look-up table contains 1024 entries and a length of all symbol sequences is 5 as an example, but the present application is not limited to this, and in the embodiments of the present disclosure, there is no limitation on parameters of the input look-up table, i.e., it is applicable to look-up tables with different symbol sequence lengths and different entry amounts.

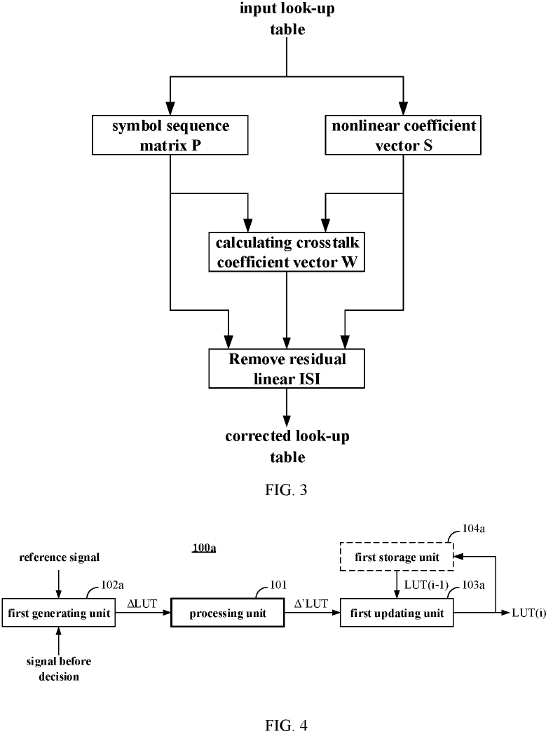

FIG. 3 is a schematic diagram of another implementation of the processing unit 101. As shown in FIG. 3, in some embodiments, the processing unit 101 is configured to:
calculate a crosstalk coefficient vector W between a symbol sequence matrix P and a nonlinear coefficient vector S of the input look-up table;
calculate the linear ISI by using the crosstalk coefficient vector W; and
remove the linear ISI from the nonlinear coefficient vector S to obtain the processed look-up table.

The look-up table as shown in Table 1 is still taken as an input look-up table as an example. A symbol sequence matrix P of 1024×5 and a nonlinear coefficient vector S = [Δ1 Δ2 ... Δ1024]^{T} of 1024x1 can be obtained according to this look-up table. The crosstalk coefficient of the residual linear ISI can be represented as a weight coefficient vector W of 5×1, then a total estimated value of the residual linear ISI is S′ = P × W. An accurate W value can be obtained by minimizing nonlinear distortion amount MSE_{NLD} = average(|S - S′|²) in which the residual linear ISI has been removed. This Equation is the same as a mean square error formula pro forma, thus W can be directly calculated using a normal equation (i.e., minimum mean square error (MMSE)), i.e.:

$$W = {\left({P}^{T} P\right)}^{- 1} {P}^{T} S$$

In the above Equation, PT is transpose of the matrix P. Thereby, a nonlinear coefficient vector of a look-up table in which the residual linear ISI is removed can be obtained, i.e.:

$$S - {S}^{′} = S - \text{P} \times \text{W} = S - P {\left({P}^{T} P\right)}^{- 1} {P}^{T} S$$

Similarly, by replacing S in the input look-up table with S - S′ , a corrected look-up table (i.e., a processed look-up table) can be outputted from the processing unit 101.

The above two implementations of the processing unit 101 are just examples, the present disclosure is not limited thereto. The processing unit 101 can also perform suppression or removal processing on residual linear ISI contained in an input look-up table in an iterative update process of a look-up table in other ways to obtain a processed look-up table in which the linear ISI is removed.

For example, the processing unit 101 can also multiply the input look-up table by a first factor α to obtain the processed look-up table. Thereby, by introducing the first factor α, the influence of the residual linear ISI can be suppressed to prevent divergence of look-up table coefficients.

In the above embodiments, the processing unit 101 can be realized via a multiplier, but the present disclosure is not limited to this, the function of the processing unit 101 can be also realized by way of software.

In the above embodiments, a value of the first factor α is greater than 0 and less than 1. For example, the value of the first factor α can be 0.95, thereby an iteration update speed and nonlinear preperformance of a look-up table may be balanced, but the present disclosure is not limited to this, as described above, the value of the first factor α can be any value between 0 and 1.

In the embodiments of the present disclosure, the processing unit 101 can perform residual linear ISI suppression processing on any look-up table in an iterative update process of a look-up table. For example, the processing unit 101 can perform residual linear ISI suppression processing on a generated first look-up table ΔLUT, or perform residual linear ISI suppression processing on a look-up table LUT(i-1) before update, or perform residual linear ISI suppression processing on an updated look-up table (a look-up table obtained by updating the first look-up table ΔLUT according to the look-up table LUT(i-1) before update), which are described respectively in the following description.

In some embodiments, the processing unit 101 performs residual linear ISI suppression processing on the generated first look-up table ΔLUT.

FIG. 4 is a schematic diagram of an apparatus 100a for updating a non-linear look-up table in the above embodiments, as shown in FIG. 4, the apparatus 100a includes: a processing unit 101, a first generating unit 102a, a first updating unit 103a and a first storage unit 104a.

The first generating unit 102a is configured to generate a first look-up table ΔLUT according to a reference signal and a signal before decision, the first look-up table ΔLUT being the input look-up table; the processing unit 101 is configured to perform linear ISI suppression processing on the first look-up table ΔLUT to obtain a second look-up table Δ‘LUT and take it as the processed look-up table; the first storage unit 104a is configured to save a look-up table LUT(i-1) before update; the first updating unit 103a is configured to update the second look-up table Δ’LUT according to the look-up table LUT(i-1) before update to obtain the updated look-up table LUT(i).

In the above embodiments, by performing linear ISI suppression processing on the generated first look-up table ΔLUT in an iterative update process of a look-up table, residual linear ISI can be eliminated or suppressed, divergence of LUT coefficients along an iterative update is avoided. And, by feeding back an updated LUT to an optical transmitter in real time, dynamic and adaptive pre-compensation on the nonlinear of an optical transmitter device can be realized.

In the above embodiments, the reference signal is for example a signal after decision, the signal after decision is a signal obtained by a decider of an optical receiver by performing decision on a signal before decision after Digital Signal Processing (DSP). As for specific implementations of the digital signal processing and decision, related technologies can be referred to, description is omitted here. However, the present disclosure is not limited to this, the reference signal may also be a pre-set training sequence or a payload with known symbol information, etc.

In the above embodiments, the signal before decision is a signal obtained by a signal processor of the optical receiver by performing digital signal processing on a signal after analog-digital conversion processing. As for specific implementations of the analog-digital conversion processing and digital signal processing, related technologies can be referred to, description is omitted here.

In the above embodiments, the first generating unit 102a obtains the first look-up table ΔLUT through calculation by using the signal after decision (or a pre-set sequence or a payload with known symbol information) and the signal before decision (a signal after digital signal processing). The present disclosure does not limit a specific calculation method, for example such method can be realized based on existing look-up table generation technologies.

By taking a PAM4 signal as an example, if a symbol sequence length of a look-up table is selected to be 5, a look-up table containing 4⁵ = 1024 entries is obtained, as shown in Table 2.

Table 2

| Symbol sequences with a length being 5 | Nonlinear coefficients |
|---|---|
| [-3 -3 -3 -3 -3] | Δ 1 |
| [-3 -3 -3 -3 -1] | Δ 2 |
| ...... | ...... |
| [33333] | Δ 1024 |

In Table 2, Δ1 to Δ1024 respectively represent a first entry to a 1024th entry, a value of a nonlinear coefficient of each entry is obtained through calculation by a taken look-up table generation technology, description is omitted here. The above Table 2 is just one example of a look-up table, the present disclosure is not limited to this.

In the above embodiments, the first storage unit 104a saves a look-up table LUT(i-1) before update, the look-up table LUT(i-1) before update is an updated look-up table saved at the last time of iterative update of a LUT. In addition, the first storage unit 104a further saves the updated look-up table LUT(i), and takes the updated look-up table LUT(i) as a look-up table before update used for a next time of update of the look-up table. At each time of iterative update of the LUT, the look-up table LUT(i-1) before update is read and outputted from the first storage unit 104a firstly, then the updated look-up table LUT(i) is saved.

In the above embodiments, a storage size of the first storage unit 104a is set based on an actual need, it may be set to save only one LUT, i.e., after completion of each update, LUT(i-1) is covered when the LUT(i) is saved. However, the present disclosure is not limited to this, the first storage unit 104a can be also set to save m historical LUTs, so as to facilitate data analysis.

In the above embodiments, there is no limitation on an implementation mode for the first storage unit 104a, it can be realized via any implementable memory, which are not listed in detail herein. Moreover, the first storage unit 104a is optional, a function of the first storage unit 104 can be also realized through other means and modes, so as to replace the first storage unit 104a.

In the above embodiments, the processing unit 101 can perform suppression processing on residual linear ISI contained in an input look-up table (the first look-up table ΔLUT) by adopting modes in FIG. 2 or FIG. 3, the present disclosure is not limited to this.

In the above embodiments, the first updating unit 103a updates the processed look-up table Δ′LUT according to the look-up table LUT(i-1) before update to obtain the updated look-up table LUT(i).

For example, the first updating unit 103a can perform an add operation directly for the input two look-up tables (LUT(i-1) and Δ′LUT) to obtain the updated look-up table LUT(i), i.e.:

$$\text{LUT} \left(\text{i}\right) \text{=LUT} \left(\text{i-1}\right) \text{+} {Δ}^{′} L U T$$

In the above embodiments, the first updating unit 103a can be realized via an adder. The present disclosure is not limited to this, the first updating unit 103a can also perform other operations for the input two look-up tables to obtain the updated look-up table LUT(i).

In some embodiments, the processing unit 101 performs residual linear ISI suppression processing on the look-up table LUT(i-1) before update.

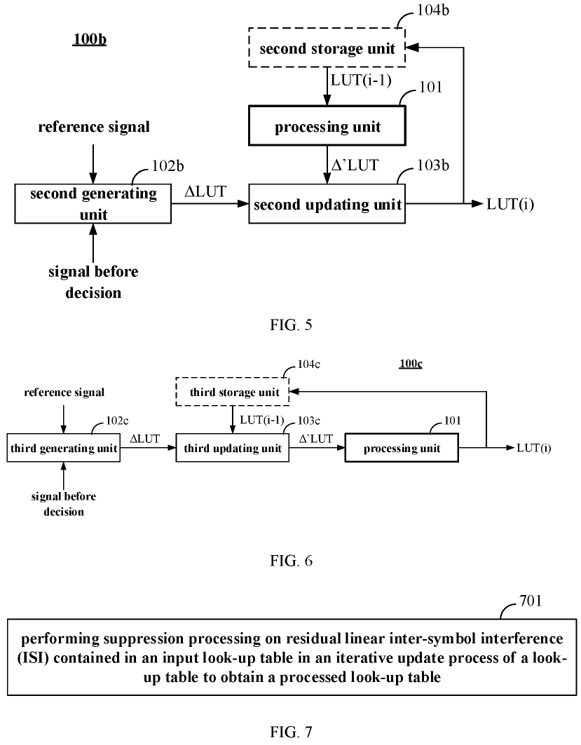

FIG. 5 is a schematic diagram of an apparatus 100b for updating a non-linear look-up table in the above embodiments, as shown in FIG. 5, the apparatus 100b includes: a processing unit 101, a second generating unit 102b, a second updating unit 103b and a second storage unit 104b.

In the above embodiments, the second generating unit 102b is configured to generate a first look-up table ΔLUT according to a reference signal and a signal before decision; the second storage unit 104b is configured to save a look-up table LUT(i-1) before update, the look-up table LUT(i-1) before update being the input look-up table; the processing unit 101 is configured to perform linear ISI suppression processing on the look-up table LUT(i-1) before update to obtain a second look-up table Δ‘LUT and take it as the processed look-up table; the second updating unit 103b is configured to update the first look-up table ΔLUT according to the second look-up table Δ’LUT to obtain the updated look-up table LUT(i).

In the above embodiments, by performing linear ISI suppression processing on the look-up table LUT(i-1) before update in an iterative update process of a look-up table, residual linear ISI can be eliminated or suppressed, divergence of LUT coefficients along an iterative update is avoided. And, by feeding back an updated LUT to an optical transmitter in real time, dynamic and adaptive pre-compensation on the nonlinear of an optical transmitter device can be realized.

In the above embodiments, an implementation mode of the second generating unit 102b is same as that of the first generating unit 102a, its content is combined here and is not repeatedly described herein.

In the above embodiments, similar to the processing of the first storage unit 104a, the second storage unit 104b saves a look-up table LUT(i-1) before update, the look-up table LUT(i-1) before update is an updated look-up table saved at the last time of iterative update of a LUT. In addition, the second storage unit 104b further saves a updated look-up table LUT(i), and takes the updated look-up table LUT(i) as a look-up table before update used for a next time of update of the look-up table. At each time of iterative update of the LUT, the look-up table LUT(i-1) before update is read and outputted from the second storage unit 104b firstly, then the updated look-up table LUT(i) is saved.

In the above embodiments, the processing unit 101 can perform suppression processing on residual linear ISI contained in an input look-up table (the look-up table LUT(i-1) before update) by adopting the way in FIG. 2 or FIG. 3, or can remove residual linear ISI contained in the input look-up table (the look-up table LUT(i-1) before update) by multiplying the input look-up table (the look-up table LUT(i-1) before update) by a first factor α. The present disclosure is not limited to this.

In the above embodiments, similar to the processing of the first updating unit 103a, the second updating unit 103b can obtain the updated look-up table LUT(i) by adding input look-up tables (the first look-up table ΔLUT and the processed look-up table Δ′LUT). However, the present disclosure is not limited to this.

In some embodiments, the processing unit 101 performs residual linear ISI suppression processing on the updated look-up table (a look-up table obtained by updating the first look-up table ΔLUT according to the look-up table LUT(i-1) before update, the obtained look-up table is referred to as the second look-up table Δ′LUT).

FIG. 6 is a schematic diagram of an apparatus 100c for updating a non-linear look-up table in the above embodiments, as shown in FIG. 6, the apparatus 100c includes: a processing unit 101, a third generating unit 102c, a third updating unit 103c and a third storage unit 104c.

In the above embodiments, the third generating unit 102c is configured to generate a first look-up table ΔLUT according to a reference signal and a signal before decision; the third storage unit 104c is configured to save a look-up table LUT(i-1) before update; the third updating unit 103c is configured to update the first look-up table ΔLUT according to the look-up table LUT(i-1) before update to obtain a second look-up table Δ‘LUT, the second look-up table Δ’LUT being the input look-up table; the processing unit 101 is configured to perform linear ISI suppression processing on the second look-up table Δ′LUT to obtain an updated look-up table LUT(i) and take it as the processed look-up table.

In the above embodiments, by performing linear ISI suppression processing on the updated look-up table in an iterative update process of a look-up table (a look-up table obtained by updating the first look-up table ΔLUT according to the look-up table LUT(i-1) before update, the obtained look-up table is referred to as the second look-up table Δ′LUT), residual linear ISI can be eliminated or suppressed, divergence of LUT coefficients along an iterative update is avoided. And, by feeding back an updated LUT to an optical transmitter in real time, dynamic and adaptive pre-compensation on the nonlinear of an optical transmitter device can be realized.

In the above embodiments, an implementation mode of the third generating unit 102c is same as that of the first generating unit 102a, its content is combined here and is not repeatedly described herein.

In the above embodiments, similar to the processing of the first storage unit 104a, the third storage unit 104c saves a look-up table LUT(i-1) before update, the look-up table LUT(i-1) before update is an updated look-up table saved at the last time of iterative update of a LUT. In addition, the third storage unit 104c further saves the updated look-up table LUT(i), and takes the updated look-up table LUT(i) as a look-up table before update used for a next time of update of the look-up table. At each time of iterative update of the LUT, the look-up table LUT(i-1) before update is read and outputted from the third storage unit 104c firstly, then the updated look-up table LUT(i) is saved.

In the above embodiments, the processing unit 101 can perform suppression processing on residual linear ISI contained in an input look-up table (the second look-up table Δ‘LUT) by adopting the way in FIG. 2 or FIG. 3, or can remove residual linear ISI contained in the input look-up table (the second look-up table Δ’LUT) by multiplying the input look-up table (the second look-up table Δ′LUT) by a first factor α. The present disclosure is not limited to this.

In the above embodiments, similar to the processing of the first updating unit 103a, the third updating unit 103c can obtain the second look-up table Δ′LUT by adding input look-up tables (the look-up table LUT(i-1) before update and the first look-up table ΔLUT). However, the present disclosure is not limited to this.

The above FIG. 4 to FIG. 6 respectively take an input look-up table being a generated first look-up table ΔLUT, a look-up table LUT(i-1) before update and an updated look-up table (a look-up table obtained by updating the first look-up table ΔLUT according to the look-up table LUT(i-1) before update) as an example, but the present disclosure is not limited to this, residual linear ISI suppression processing can be performed on any look-up table involved in an update process of a look-up table by the processing unit of the present disclosure, description is omitted here.

It’s worth noting that the above FIG. 1 to FIG. 6 are only schematic description of the embodiments of the present disclosure, but the present disclosure is not limited to this. For example, each component can be adjusted appropriately, moreover, some other components can be increased or some of the components can be reduced. Persons skilled in the art can make appropriate modifications according to the above contents, not limited to the records in the above FIG. 1 to FIG. 6.

Each of the above embodiments is only illustrative for the embodiments of the present disclosure, but the present disclosure is not limited to this, appropriate modifications can be also made based on the above each embodiment. For example, the above each embodiment can be used separately, or one or more of the above embodiments can be combined.

Through the apparatus in the present embodiment, residual linear ISI is eliminated or suppressed in an iterative update process of a LUT, divergence of LUT coefficients along an iterative update is avoided.

### Embodiments of the Second Aspect

The embodiments of the present disclosure provide a method for updating a non-linear look-up table. The principles of the method to solve the problem are similar to the apparatus in the embodiments of the first aspect, thus its specific implementation can refer to the implementation of the apparatus in the embodiments of the first aspect, the same contents will not be repeated.

FIG. 7 is a schematic diagram of an implementation of a method for updating a non-linear look-up table of the embodiments of the present disclosure, as shown in FIG. 7, the method includes:

701: performing suppression processing on residual linear inter-symbol interference (ISI) contained in an input look-up table in an iterative update process of a look-up table to obtain a processed look-up table.

Through the method in the present embodiment, residual linear ISI is eliminated or suppressed in an iterative update process of a LUT, divergence of LUT coefficients along an iterative update is avoided.

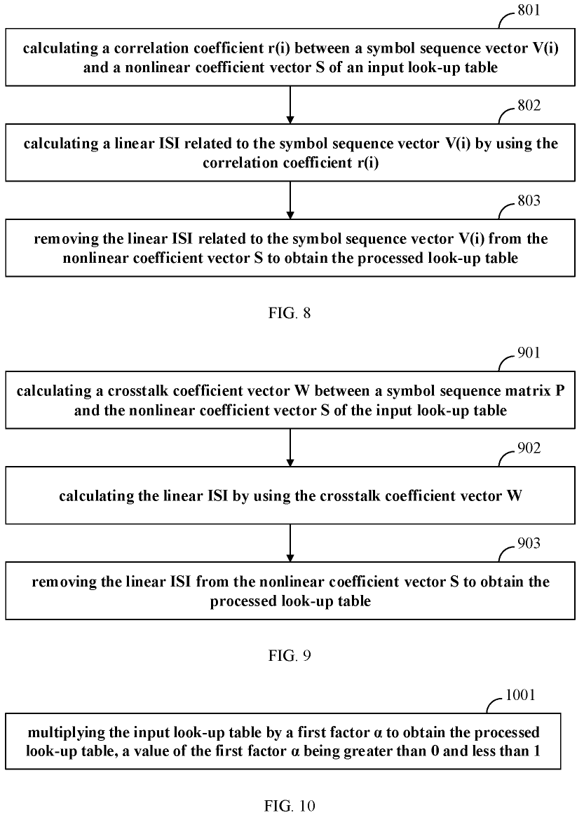

FIG. 8 is a schematic diagram of an implementation of 701, as shown in FIG. 8, the method includes:
801: calculating a correlation coefficient r(i) between a symbol sequence vector V(i) and a nonlinear coefficient vector S of an input look-up table;
802: calculating a linear ISI related to the symbol sequence vector V(i) by using the correlation coefficient r(i);
803: removing the linear ISI related to the symbol sequence vector V(i) from the nonlinear coefficient vector S to obtain the processed look-up table.

FIG. 9 is a schematic diagram of another implementation of 701, as shown in FIG. 9, the method includes:
901: calculating a crosstalk coefficient vector W between a symbol sequence matrix P and the nonlinear coefficient vector S of the input look-up table;
902: calculating the linear ISI by using the crosstalk coefficient vector W;
903: removing the linear ISI from the nonlinear coefficient vector S to obtain the processed look-up table.

FIG. 10 is a schematic diagram of a further implementation of 701, as shown in FIG. 10, the method includes:

1001: multiplying the input look-up table by a first factor α to obtain the processed look-up table, a value of the first factor α being greater than 0 and less than 1.

In some embodiments, a value of the first factor α is 0.95.

FIG. 11 is a schematic diagram of another implementation of a method for updating a non-linear look-up table of the embodiments of the present disclosure, in this implementation, the input look-up table is the generated first look-up table ΔLUT. As shown in FIG. 11, the method includes:
1101: generating a first look-up table ΔLUT according to a reference signal and a signal before decision, the first look-up table ΔLUT being the input look-up table;
1102: performing linear ISI suppression processing on the first look-up table ΔLUT to obtain a second look-up table Δ′LUT and take it as the processed look-up table;
1103: updating the second look-up table Δ′LUT according to the look-up table LUT(i-1) before update to obtain the updated look-up table LUT(i);
1104: saving the updated look-up table LUT(i), and taking the updated look-up table LUT(i) as a look-up table before update used for a next time of update of the look-up table.

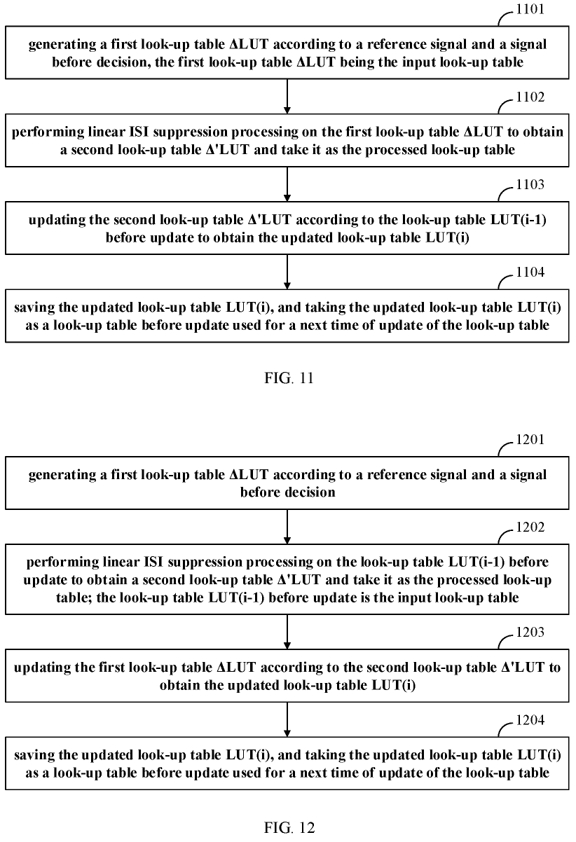

FIG. 12 is a schematic diagram of a further implementation of a method for updating a non-linear look-up table of the embodiments of the present disclosure, in this implementation, the input look-up table is the look-up table LUT(i-1) before update. As shown in FIG. 12, the method includes:
1201: generating a first look-up table ΔLUT according to a reference signal and a signal before decision;
1202: performing linear ISI suppression processing on the look-up table LUT(i-1) before update to obtain a second look-up table Δ′LUT and take it as the processed look-up table; the look-up table LUT(i-1) before update is the input look-up table;
1203: updating the first look-up table ΔLUT according to the second look-up table Δ′LUT to obtain the updated look-up table LUT(i);
1204: saving the updated look-up table LUT(i), and taking the updated look-up table LUT(i) as a look-up table before update used for a next time of update of the look-up table.

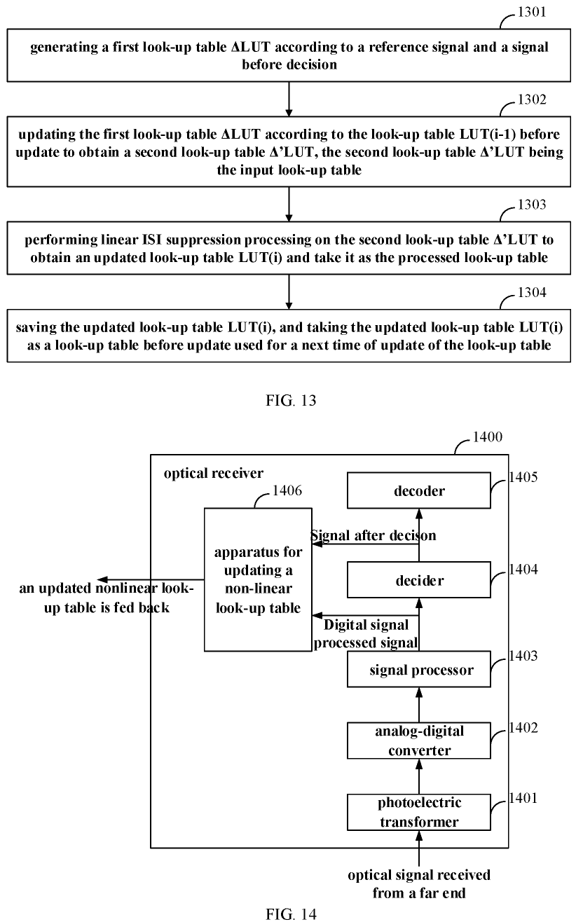

FIG. 13 is a schematic diagram of a more implementation of a method for updating a non-linear look-up table of the embodiments of the present disclosure, in this implementation, the input look-up table is the updated look-up table LUT(i). For the sake of illustration, the updated look-up table LUT(i) is referred to as the second look-up table Δ′LUT. As shown in FIG. 13, the method includes:
1301: generating a first look-up table ΔLUT according to a reference signal and a signal before decision;
1302: updating the first look-up table ΔLUT according to the look-up table LUT(i-1) before update to obtain a second look-up table Δ‘LUT, the second look-up table Δ’LUT being the input look-up table;
1303: performing linear ISI suppression processing on the second look-up table Δ′LUT to obtain an updated look-up table LUT(i) and take it as the processed look-up table;
1304: saving the updated look-up table LUT(i), and taking the updated look-up table LUT(i) as a look-up table before update used for a next time of update of the look-up table.

It’s worth noting that the above FIG. 7 to FIG. 13 are only schematic description of the embodiments of the present disclosure, but the present disclosure is not limited to this. For example, each step can be adjusted appropriately, moreover, some other steps can be increased or some of the steps can be reduced. Persons skilled in the art can make appropriate modifications according to the above contents, not limited to the records in the above FIG. 7 to FIG. 13.

Each of the above embodiments is only illustrative for the embodiments of the present disclosure, but the present disclosure is not limited to this, appropriate modifications can be also made based on the above each embodiment. For example, the above each embodiment can be used separately, or one or more of the above embodiments can be combined.

Through the method in the present embodiment, residual linear ISI is eliminated or suppressed in an iterative update process of a LUT, divergence of LUT coefficients along an iterative update is avoided.

### Embodiments of the Third Aspect

The embodiments of the present disclosure provide an optical receiver.

FIG. 14 is a schematic diagram of an example of an optical receiver 1400 of the embodiments of the present disclosure. As shown in FIG. 14, the optical receiver 1400 includes: a photoelectric transformer 1401, an analog-digital converter 1402, a signal processor 1403, a decider 1404, a decoder 1405 and an apparatus 1406 for updating a non-linear look-up table.

In the embodiments of the present disclosure, the photoelectric transformer 1401 performs photoelectric transformation on a received optical signal to obtain a photoelectric transformed signal (an electrical signal); the analog-digital converter 1402 performs analog-digital conversion on the photoelectric transformed signal to obtain an analog-digital converted signal (a digital signal); the signal processor 1403 performs digital signal processing on the analog-digital converted signal to obtain a digital signal processed signal (symbol sequence containing a certain error); the decider 1404 performs decision on the digital signal processed signal to obtain a signal after decision (a corresponding symbol after decision); the decoder 1405 decodes the signal after decision to obtain a decoded signal (restored to a transmitted data bit stream).

In the above embodiments, the signal processor 1403 can process the analog-digital converted signal based on a prior art, for example, for a dual-polarization quadrature amplitude modulation (DP-QAM) signal, digital processing can include resampling, orthogonalization, an adaptive equalization polarization demultiplexing based on a constant modulus algorithm, frequency offset estimation and carrier phase recovery, etc. For signals of other modulation formats, such as a pulse amplitude modulation (PAM) signal widely used in an intensity modulation-direct detection (IM-DD) system, the signal processor 1403 can also adopt corresponding mature DSP.

In the above embodiments, the decider 1404 can adopt a deciding mode by means of hard decision or soft decision, the present disclosure does not limit this.

It’s worth noting that the present disclosure does not limit implementations of the photoelectric transformer 1401, the analog-digital converter 1402, the signal processor 1403, the decider 1404 and the decoder 1405, related technologies of optical receivers can be referred to.

In the embodiments of the present disclosure, the apparatus 1406 for updating a non-linear look-up table may be the apparatus in the embodiments of the first aspect to realize the method in the embodiments of the second aspect. For example, after receiving the signal after decision and the digital signal processed signal, an updated look-up table is outputted in real time and is fed back to an optical transmitter at peer end. For a detailed processing process, the embodiments of the first aspect and the embodiments of the second aspect can be referred to, description is omitted here.

In the above embodiments, taking that the apparatus 1406 for updating a non-linear look-up table is configured in the optical receiver 1400 as an example, but the present disclosure is not limited to this, the apparatus 1406 for updating a non-linear look-up table can be also configured at the side of the optical receiver 1400, for example is configured to be a chip or product, etc. coupled to the optical receiver 1400.

The embodiments of the present disclosure also provide an optical transmitter.

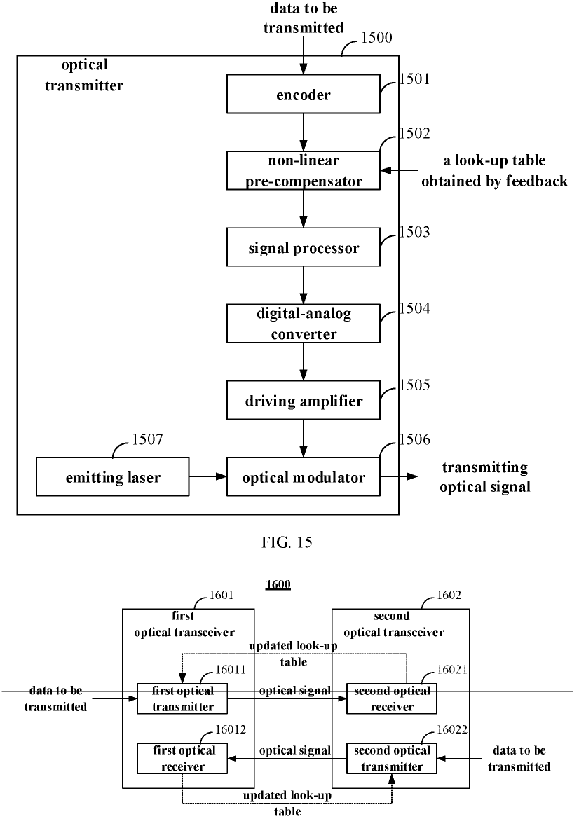

FIG. 15 is a schematic diagram of an example of an optical transmitter 1500 of the embodiments of the present disclosure. As shown in FIG. 15, the optical transmitter includes: an encoder 1501, a non-linear pre-compensator 1502, a signal processor 1503, a digital-analog converter 1504, a driving amplifier 1505, an optical modulator 1506 and an emitting laser 1507.

In the embodiments of the present disclosure, a to-be-transmitted bitstream data signal becomes a symbol sequence after being encoded by the encoder 1501, the non-linear pre-compensator 1502 performs non-linear pre-compensation using a look-up table obtained by feedback, after being processed by the signal processor 1503, a pre-compensated signal becomes a signal that can be processed by the digital-analog converter 1504, after being amplified by the driving amplifier 1505, an electrical signal outputted by the digital-analog converter 1504 is inputted to a radio frequency input end of the optical modulator 1506, the optical modulator 1506 loads the electrical signal onto an optical signal via the emitting laser 1507 and transmits the electrical signal to an optical receiver at peer end.

In the above embodiments, the signal processor 1503 can perform digital signal processing on a pre-compensated signal based on a prior art, such as: up-sampling, pulse shaping, linear pre-equalization, root-mean-square value locking, peak value clipping, resampling and quantifying, etc., related technologies can be referred to, description is omitted here.

It’s worth noting that the present disclosure does not limit implementations of the encoder 1501, the non-linear pre-compensator 1502, the signal processor 1503, the digital-analog converter 1504, the driving amplifier 1505, the optical modulator 1506 and the emitting laser 1507, related technologies of optical transmitters can be referred to.

The embodiments of the present disclosure also provide a transceiver, including an optical transmitter and an optical receiver, the optical transmitter transmits an optical signal to an optical receiver at peer end, FIG. 15 can be referred to for its structure, but the present disclosure is not limited to this; the optical receiver receives an optical signal transmitted by an optical transmitter at peer end, FIG. 14 can be referred to for its structure, but the present disclosure is not limited to this.

Through the optical receiver in the present embodiment, residual linear ISI is eliminated or suppressed in an iterative update process of a LUT, divergence of LUT coefficients along an iterative update is avoided.

### Embodiment 4

The embodiments of the present disclosure provide an optical communication system.

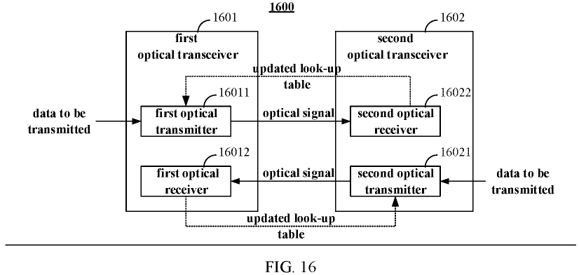

FIG. 16 is a schematic diagram of an optical communication system 1600 of the embodiments of the present disclosure. As shown in FIG. 16, the optical communication system 1600 includes a first optical transceiver 1601 and a second optical transceiver 1602, the first optical transceiver 1601 includes a first optical transmitter 16011 and a first optical receiver 16012, the second optical transceiver 1602 includes a second optical transmitter 16021 and a second optical receiver 16022.

In some embodiments, the first optical transmitter 16011 transmits an optical signal to the second optical receiver 16022, the second optical receiver 16022 receives the optical signal, the second optical receiver 16022 includes an apparatus for updating a non-linear look-up table described in the embodiments of the first aspect, configured to update the non-linear look-up table and feed back the same to the first optical transmitter 16011.

In some embodiments, the second optical transmitter 16021 transmits an optical signal to the first optical receiver 16012, the first optical receiver 16012 receives the optical signal, the first optical receiver 16012 includes an apparatus for updating a non-linear look-up table described in the embodiments of the first aspect, configured to update the non-linear look-up table and feed back the same to the second optical transmitter 16021.

Since the apparatus for updating a non-linear look-up table has been described in details in the embodiments of the first aspect, its content is combined here and will not be repeated here.

The embodiments of the present disclosure also provide a computer readable program, wherein when the program is executed in the apparatus for updating a non-linear look-up table, the program enables the apparatus for updating a non-linear look-up table to perform the method described in the embodiments of the second aspect.

The embodiments of the present disclosure provide a storage medium storing a computer readable program, wherein the computer readable program enables the apparatus for updating a non-linear look-up table to perform the method described in the embodiments of the second aspect.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more functional block diagrams and/or one or more combinations of the functional block diagrams as shown in the figures may correspond to software modules of a computer program flow, or may correspond to hardware modules. These software modules may respectively correspond to the steps as shown in the figures. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium can be coupled to a processor, thereby enabling the processor to read information from the storage medium, and to write the information into the storage medium; or the storage medium can be a constituent part of the processor. The processor and the storage medium can be located in an ASIC. The software module can be stored in a memory of a mobile terminal, and may also be stored in a memory card that can be plugged into a mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the figures can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the figures can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the principle of the present disclosure, these variations and modifications are also within the scope of the present disclosure.

As for the implementations including the above embodiments, the following supplements are also disclosed:
1. A method for updating a non-linear look-up table, wherein the method includes:
   performing suppression processing on residual linear ISI contained in an input look-up table in an iterative update process of a look-up table to obtain a processed look-up table.
2. The method according to the supplement 1, wherein performing suppression processing on residual linear ISI contained in an input look-up table includes:
   calculating a correlation coefficient r(i) between a symbol sequence vector V(i) and a nonlinear coefficient vector S of the input look-up table;
   calculating a linear ISI related to the symbol sequence vector V(i) by using the correlation coefficient r(i); and
   removing the linear ISI related to the symbol sequence vector V(i) from the nonlinear coefficient vector S to obtain the processed look-up table.
3. The method according to the supplement 1, wherein performing suppression processing on residual linear ISI contained in an input look-up table includes:
   calculating a crosstalk coefficient vector W between a symbol sequence matrix P and a nonlinear coefficient vector S of the input look-up table;
   calculating the linear ISI by using the crosstalk coefficient vector W; and
   removing the linear ISI from the nonlinear coefficient vector S to obtain the processed look-up table.
4. The method according to the supplement 1, wherein performing suppression processing on residual linear ISI contained in an input look-up table includes:
   multiplying the input look-up table by a first factor α to obtain the processed look-up table, a value of the first factor α being greater than 0 and less than 1.
5. The method according to the supplement 4, wherein the value of the first factor α is 0.95.
6. The method according to any one of the supplements 1∼3, wherein the method includes:
   generating a first look-up table ΔLUT according to a reference signal and a signal before decision, the first look-up table ΔLUT being the input look-up table;
   performing linear ISI suppression processing on the first look-up table ΔLUT to obtain a second look-up table Δ′LUT and take it as the processed look-up table;
   updating the second look-up table Δ′LUT according to the look-up table LUT(i-1) before update to obtain the updated look-up table LUT(i);
   saving the updated look-up table LUT(i), and taking the updated look-up table LUT(i) as a look-up table before update used for a next time of update of the look-up table.
7. The method according to any one of the supplements 1~5, wherein the method includes:
   generating a first look-up table ΔLUT according to a reference signal and a signal before decision;
   performing linear ISI suppression processing on the look-up table LUT(i-1) before update to obtain a second look-up table Δ′LUT and take it as the processed look-up table; the look-up table LUT(i-1) before update is the input look-up table;
   updating the first look-up table ΔLUT according to the second look-up table Δ′LUT to obtain the updated look-up table LUT(i);
   saving the updated look-up table LUT(i), and taking the updated look-up table LUT(i) as a look-up table before update used for a next time of update of the look-up table.
8. The method according to any one of the supplements 1~5, wherein the method includes:
   generating a first look-up table ΔLUT according to a reference signal and a signal before decision;
   updating the first look-up table ΔLUT according to the look-up table LUT(i-1) before update to obtain a second look-up table Δ‘LUT, the second look-up table Δ’LUT being the input look-up table;
   performing linear ISI suppression processing on the second look-up table Δ′LUT to obtain an updated look-up table LUT(i) and take it as the processed look-up table,
   saving the updated look-up table LUT(i), and taking the updated look-up table LUT(i) as a look-up table before update used for a next time of update of the look-up table.
9. An optical transceiver, including an optical transmitter and an optical receiver, the optical receiver including an apparatus for updating a non-linear look-up table configured to perform a method for updating a non-linear look-up table according to any one of the supplements 1 to 8.
10. An optical communication system, including a first optical transceiver and a second optical transceiver,
   the first optical transceiver includes a first optical transmitter and a first optical receiver,
   the second optical transceiver includes a second optical transmitter and a second optical receiver,
   the first optical transmitter sends an optical signal to the second optical receiver, the second optical receiver includes an apparatus for updating a non-linear look-up table configured to perform a method for updating a non-linear look-up table according to any one of the supplements 1 to 8; and/or
   the second optical transmitter sends an optical signal to the first optical receiver, the first optical receiver includes an apparatus for updating a non-linear look-up table configured to perform a method for updating a non-linear look-up table according to any one of the supplements 1 to 8.

What is claimed is:

1. An apparatus for updating a non-linear look-up table, the apparatus comprising:
a processor configured to perform suppression processing on residual linear inter-symbol interference (ISI) contained in an input look-up table in an iterative update process of a look-up table to obtain a processed look-up table.

2. The apparatus according to claim 1, wherein the processor is configured to:
calculate a correlation coefficient r(i) between a symbol sequence vector V(i) and a nonlinear coefficient vector S of the input look-up table;
calculate a linear ISI related to the symbol sequence vector V(i) by using the correlation coefficient r(i); and
remove the linear ISI related to the symbol sequence vector V(i) from the nonlinear coefficient vector S to obtain the processed look-up table.

3. The apparatus according to claim 1, wherein the processor is configured to:
calculate a crosstalk coefficient vector W between a symbol sequence matrix P and a nonlinear coefficient vector S of the input look-up table;
calculate the linear ISI by using the crosstalk coefficient vector W; and
remove the linear ISI from the nonlinear coefficient vector S to obtain the processed look-up table.

4. The apparatus according to claim 1, wherein the processor is configured to:
multiply the input look-up table by a first factor α to obtain the processed look-up table, a value of the first factor α being greater than 0 and less than 1.

5. The apparatus according to claim 4, wherein the value of the first factor α is 0.95.

6. The apparatus according to claim 1, wherein the apparatus further comprises a storage and the processor is configured to:
generate a first look-up table ΔLUT according to a reference signal and a signal before decision, the first look-up table ΔLUT being the input look-up table,
perform linear ISI suppression processing on the first look-up table ΔLUT to obtain a second look-up table ΔʹLUT which is taken as the processed look-up table,
wherein the storage being configured to save a look-up table LUT(i-1) before update,
wherein the processor is configured to update the second look-up table ΔʹLUT according to the look-up table LUT(i-1) before update to obtain the updated look-up table LUT(i); and
the storage is further configured to save the updated look-up table LUT(i), and take the updated look-up table LUT(i) as a look-up table before update used for a next time of update of the look-up table.

7. The apparatus according to claim 1, wherein the apparatus further comprises a storage and the processor is configured to: generate a first look-up table ΔLUT according to a reference signal and a signal before decision,
save a look-up table LUT(i-1) before update, the look-up table LUT(i-1) before update being the input look-up table,
the processor being configured to:
perform linear ISI suppression processing on the look-up table LUT(i-1) before update to obtain a second look-up table ΔʹLUT and being taken as the processed look-up table,
update the first look-up table ΔLUT according to the second look-up table ΔʹLUT to obtain the updated look-up table LUT(i);
wherein the storage is further configured to save the updated look-up table LUT(i), and take the updated look-up table LUT(i) as a look-up table before update used for a next time of update of the look-up table.

8. The apparatus according to claim 1, wherein the apparatus further comprises a storage and the processor is further configured to:
generate a first look-up table ΔLUT according to a reference signal and a signal before decision,
wherein the storage is configured to save a look-up table LUT(i-1) before update,
the processor is further configured to:
update the first look-up table ΔLUT according to the look-up table LUT(i-1) before update to obtain a second look-up table Δ′LUT, the second look-up table ΔʹLUT being the input look-up table,
perform linear ISI suppression processing on the second look-up table ΔʹLUT to obtain an updated look-up table LUT(i) which is taken as the processed look-up table,
wherein the storage is further configured to save the updated look-up table LUT(i), and take the updated look-up table LUT(i) as a look-up table before update used for a next time of update of the look-up table.

9. A method for updating a non-linear look-up table, the method comprising:
performing suppression processing on residual linear inter-symbol interference (ISI) contained in an input look-up table in an iterative update process of a look-up table to obtain a processed look-up table.

10. An optical receiver, comprising:
a photoelectric converter configured to perform photoelectric conversion on a received optical signal to obtain a photoelectrically converted signal;
an analog-to-digital converter configured to perform analog-to-digital conversion on the photoelectrically converted signal to obtain an analog-to-digital converted signal;
a signal processor configured to perform digital signal processing on the analog-to-digital converted signal to obtain a signal after digital signal processing;
a decider configured to perform decision on the signal after digital signal processing to obtain a signal after decision; and
a decoder configured to decode the signal after decision to obtain a decoded signal;
wherein the optical receiver further comprises:
an apparatus for updating a non-linear look-up table, which updates the non-linear look-up table according to the signal after digital signal processing and the signal after decision to obtain an updated look-up table and feedback the updated look-up table to a peer optical transmitter,
the apparatus for updating a non-linear look-up table being configured to perform suppression processing on residual linear inter-symbol interference (ISI) contained in an input look-up table in an iterative update process of a look-up table to obtain a processed look-up table.
